(19) United States
(12) Patent Application Publication
(10) Pub. No.: US 2008/0127598 A1
(43) Pub. Date: Jun. 5, 2008

(54) MESH SYSTEM

(75) Inventor: Christer Kallstrom, Naples, FL (US)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: Maestroshield IP Holdings,LLC, Naples, FL (US)

(21) Appl. No.: 12/017,667

(22) Filed: Jan. 22, 2008

Related U.S. Application Data
(63) Continuation-in-part of application No. 11/352,976, filed on Feb. 13, 2006.
Application No. 11/352,976 is a continuation-in-part of application No. PCT/US2206/012715, filed on Apr. 6, 2006.
(60) Provisional application No. 60/701,223, filed on Jul. 21, 2005.
(60) Provisional application No. 60/948,145, filed on Jul. 5, 2007.

(51) Int. Cl. E04H 9/14; E06B 9/11

(52) U.S. Cl. 52/656.7; 160/239; 52/745.21

(57) ABSTRACT

A mesh system for protecting structural openings, such as windows and doors, from storm damage or intrusion is made of a special cable having an aramid core and a twine twisted steel jacket made of a plurality of steel wires spun onto a bundled aramid fiber core. The mesh includes a substantially straight warp and a woven weft. A mesh system designed for limiting the deflection of the mesh under impact and wind load conditions imposed by a hurricane securely fixes and tensions the mesh along at least the direction of the substantially straight warp. A cable construction, cable diameter, mesh weaving loads and percent open area of the mesh are selected such that the mesh system passes a large missile impact test. Security features including periodic use of a plurality of cables and/or sensors may be added to the mesh.

### RELATED APPLICATIONS

This application claims the benefit of U.S. Pat. Prov. Appl. 60/948,145, filed Jul. 5, 2007 and is a continuation-in-part of U.S. patent application Ser. No. 11/352,976, filed on Feb. 13, 2006, and PCT/US06/12715, filed on Apr. 6, 2006, which claims priority from U.S. Pat. Prov. Appln. No. 60/701,223 filed on Jul. 21, 2005 and the specifications and drawings of both of these related applications and the provisional applications are hereby incorporated by reference in their entirety herein.

### FIELD OF THE INVENTION

The field relates generally to protective shutter systems that are resistant to hurricane force winds, flying debris, missiles, burglary and the like, especially shutter systems that prevent damage from UV rays without obscuring all visible light and providing a view from inside a building protected by the shutter system.

### BACKGROUND

Hurricane and other intensive windstorms may cause significant property damage to homes and buildings and other structures. Specifically, strong winds may cause objects to become projectiles that have enough force to shatter windows of buildings. Thereafter, dangerous winds and rain can enter the buildings and cause costly damage or even destruction of the building. Consequently, to minimize the damage of hurricanes and windstorms, many communities and insurance underwriters require hurricane shutters for the protection of buildings at risk of damage by hurricanes.

Hurricane shutters traditionally are constructed of resilient panels or hard slats that are strong enough to resist projectiles and to protect window glass from shattering upon impact. A hurricane shutter is disclosed in U.S. Pat. No. 6,209,263 to Poirer, but shutters usually obstruct the view and prevent much light from entering through shuttered windows. Roll-up storm curtains are known, such as disclosed in U.S. Pat. No. 6,851,464, to Hudoba et al. While, these roll-up curtains make opening and closing of protective shutters easier than manual installation or closing, they suffer from some of the same deficiencies as resilient panels, blocking light and obstructing the view, and many do not adequately protect against a, combination of high winds and flying debris. The test of shutter systems in Miami Dade County in Florida is a well known test for deflection caused by ejecting a two by four end first into a center portion and a corner portion of a system at a high speed (hereinafter referred to as the large missile impact test). Failure to meet this standard means that a shutter system is not hurricane resistant. Many roll-up curtains do not provide substantial protection against criminal break-in. Theft from offices and dwelling, such as prior to or during storms, may cause tremendous damage to structures if hurricane shutter systems are compromised by criminal intrusion, even if roll-up curtains might have withstood impact damage from debris and high winds.

Mesh materials have been used in hurricane protection. Mesh materials offer the promise of protection from hurricane winds and debris carried by the wind without blocking light. U.S. Pat. No. 6,865,852 discloses a mesh material used to impede small and large missile impacts and wind from damaging a structure. However, this type of mesh material is substantially impermeable to wind loads and deflects several feet under normal wind loads experienced in a hurricane. Therefore, the mesh material must be extended a large distance from windows and doors. These mesh materials are shown enveloping a structure and staked in the ground or otherwise extended out from the exterior of the structure. These mesh materials do not provide protection from theft and are not cut-resistant. Substantial loads are imposed on the structure where the mesh is supported. No mesh material is available as a protective screen that passes the Miami Dade requirements for large missile impact test and wind load and cyclic load tests. Also, large mesh nets require installation and removal with each storm and are not aesthetically approved for use in most neighborhoods for extended use.

Cables made of wire and/or polymer materials are known. U.S. Pat. No. 5,651,245 to Damion, describes a cable having a substantially metallic central core and outer strands formed from at least one layer of metal wires. Patrick, in US. Patent Publication No. US 2003/0074879, describes a yarn which includes a core formed of cut-resistant material and a wrapping yarn wound about the core. Zhu et al., in U.S. Pat. No. 7,127,879, disclose a ply-twisted yarn which includes a first multifilament yarn of continuous organic filaments and a second yarn comprising continuous inorganic filaments. Loos, in U.S. Pat. No. 4,034,547, discloses a cable having a wire rope jacket and a synthetic compressible core of filaments with a specific tensile strength greater than the members of the jacket, which serve as a reinforcing component for the jacket. Each of these references are incorporated by reference herein in their entirety for background purposes.

### SUMMARY OF THE INVENTION

A cable is used in a hurricane resistant mesh for a protective screen on a window or door, such as a glass window or door containing glass elements or a sliding glass door. For example, a bundle of parallel zero twist fibers. The fibers may be polymer fibers, such as fibers of an aramid, such as Kevlar™, Twaron™, and the like, or long chain oriented polymers, such as high modulus polyethylene, or carbon fibers, carbon tubes and nanotubes of carbon or other elements or molecules, or glass fibers, and the like, or combinations of these. The fibers form a core for metal wires spun around the core. Aramid fiber (actually a abbreviation for aromatic polyamide) is formed as a solid fiber directly from solution. Aramid fibers, such as meta-aramid and para-aramid fibers are manufactured fibers in which the fiber-forming substance is a synthetic polyamide in which at least 85% of the amide linkages, (—CO—NH—) are attached directly to two aromatic rings. Meta-aramids include Nomex™ and para-aramids include Kevlar™, which are trademarks of Dupont. High modulus polyethylene is a type of polyolefin that derives ample strength from the length of each individual molecule, even though individual molecules are joined merely by Van der Waals bonds, but molecules of a spinneret spun high modulus polyethylene fiber tend to have 100,000 to 250,000 monomers each. Also, high modulus polyethylene fibers have good chemical resistance and abrasion resistance, as well as excellent tensile strength and modulus. Preferably, the fibers for the core are selected from fibers having a large tensile modulus along the fiber length, such as some nanotubes, aramid fibers, high modulus polyethylene fibers and the like.

In one example, six 304 stainless steel strands are helically spun about an aramid core. While cables using similar construction are disclosed in U.S. Pat. No. 4,034,547, the cable made in one example provides for a mesh having very little deflection either under impinging wind loads or upon missile impact.

In one example, the gauge of the six 304 stainless steel wires, the tightness of the spinning parameters, and the openness of the mesh woven from the cables are chosen such that a mesh system, which is made with a substantially straight warp fixed securely on both ends of the warp to a structure, deflects less than three inches in a large missile impact text, according to TAS 201 and ASTM E 1886/E 1996, using a wooden 2×4 as a missile at about 50 feet/second (about 15 meters/second).

A woven mesh may be prepared with a weft cable substantially perpendicular to a warp cable. For example, in order to provide for less than three inches in deflection in the large missile impact test described, above, the weft is left comparatively straight compared to the warp, which is woven through the weft. One advantage of a tightly spun, comparatively straight weft is that deflection of the screen in a large missile impact test may be less than three inches, even for a 4 meter wide screen, if the weft is fixed at both ends to a supporting structure.

In one example, periodically, a single cable may be replaced in the warp and/or the weft by a substantially cut-resistant cable, such as plurality of cables spun, or otherwise combined, into a substantially cut-resistant bundle of cables. The individual cables may be continuous or discontinuous, such that a continuous bundle of cables extends along the width or length of a mesh providing a substantially cut-resistant security mesh. Substantially cut-resistant means that the cut-stop bundles of cables prevent cutting through a portion of the mesh for a period of at least three minutes using a knife, razor blade, even if a sawing motion is used with such a straight-edged blade, tin snips, or wire cutters. It does not mean that bolt cutters or carbide or diamond saws cannot cut through the substantially cut-resistant cable or that given enough time the mesh cannot be cut through even with a blade or wire cutters. In one example, a level 3 security cable is formed of aramid fibers and 49 steel wires, with an outer cable diameter of about 3 mm, in one example 2.5 mm, and is incorporated in a security mesh system that passes category 3 of the EMVI 1627:1999 standard for security. Each security cable is made of 49 steel wires with 7 wires spun together into a twisted twine and 7 twisted twines spun into a cable. In one example, the diameter of each wire is 0.29 mm. Thus, a screen using a periodic bundle of cables may be substantially theft resistant, as well as hurricane resistant. For example, a security mesh system having periodic reinforcement with the level 3 security cable may provide a level of a security deterrent similar to aluminum slats in an aluminum shutter system, while allowing light in and without completely obscuring the view out. One advantage of a security screen constructed using substantially cut-resistant cables or level 3 security cable is that a security screen may be fixed in place and may be releasable only from the inside of the structure or using a key or security code. Another advantage is that the security screen may be raised and lowered electronically. For example, a security mesh system may be raised automatically if a fire alarm is activated in a structure, or a security mesh system may be lowered automatically, if a security alarm is activated in a structure, or a security screen may be raised or lowered by a user of a secure control device, such as a wall panel having security code access, a encoded communication from a wireless device, or an internet device having password controlled access.

A mesh may be fixed in a structure that tightly stretches the cables in the warp direction, either vertically or horizontally. For example, two fixtures may be held in a track or on a rail installed on a structural opening, such as a window or a door of a building. The mesh may be under a tensional force in a direction of at least one of the direction of elongation of the warp or the weft or both thereof. The system may be capable of being raised and lowered, such as the mechanism used (e.g., luff rope system) in raising and lowering of a sail on a sailboat or the like.

For example, the mounting of the mesh in a fixture may be secured using a stay inserted in a fold of the mesh and one or more brackets or clamps that serve to bind the fold of the mesh on the stay. The stay or stays may be of any cross-sectional shape, such as round or flat. The fold in the mesh may be an open fold-over of mesh material or a closed loop formed at the edge of the mesh. A bracket or clamp may compress the mesh between the stay and the bracket or clamp, for example, preventing release of the mesh from the fixture that raises and lowers along a track, such as a channel, or a rail.

An advantage of a mesh compared to known shutter systems is that the mesh allows a substantial proportion of light through the mesh. Another advantage is that the mesh may allow a view from a window even when the mesh is lowered, securing the window from wind damage and/or providing a theft deterrent. In one example, a mesh having a black coating allows a person inside of a structure with limited or no lighting to see out of the windows and/or doors secured by the security mesh but substantially obscures viewing of occupants inside of the building from a passerby on the street or from a neighboring building.

An advantage of one example of a hurricane resistant mesh system is that the deflection of the mesh meets or exceeds requirements established for Miami Dade County for hurricane shutters. Yet another advantage is that impinging wind loads pass through a mesh having a certain range of open pores and the air between the safety mesh and the window and/or door builds up a buffer layer of air, providing a cushion of air between the safety mesh and the surface of the window and/or door, reducing loads on edge fixtures and preventing some deflection of the mesh toward the window and/or door. This is a surprising and unexpected result that substantially reduces the cost and failure rates of supporting structures.

In one example, a mesh has a percent open area (defined as the open area divided by the total area of the mesh) of 27.2%. For example, a mesh may have a plurality of strands having a diameter of about 0.8 millimeters (mm). The term about is understood to include ordinary and reasonable manufacturing tolerances. When referring to dimensions in millimeters for strands or cables used in meshes, the term “about” means ±0.05 mm. A mesh having 520 strands per m² by 390 strands per m² has a hole size of about 1.82 mm by 1.23 mm between nearest strands, if the mesh has a percent open area of about 27%, for example. In this specific example of mesh, wind impinging on the mesh builds a cushion of air between the underlying structure, such as a window or door, and the mesh. Thus, the mesh and its supporting structure are capable of withstanding wind loads for hurricane winds of one hundred forty miles per hour or more. One advantage of hurricane resistant mesh is that a product rated for winds of 70 miles per hour survives stronger winds provided that the retaining structure holding the mesh and the underlying structure, such as a window or door, do not fail. Counter intuitively, the amount of deflection of the mesh upon large missile impact test may be less at higher wind speeds than at lower wind speeds due to this air cushion effect.

Other advantages shall be apparent based on the examples and drawings provided in this application.

### BRIEF DESCRIPTION OF THE FIGURES

The drawings describe some example of some features, as described in the detailed description.

FIG. 1 illustrates one example of a portion of a safety mesh.

FIG. 2 illustrates another example having a two cables positioned adjacently, side-by-side every 36^{th} warp and every 50^{th} weft.

FIG. 3 illustrates a mesh held in tension at the top and bottom of the mesh.

FIG. 4 illustrates a mesh held in tension at the sides of the mesh.

FIG. 5 illustrates an exploded view of a motorized roll up assembly.

FIGS. 6A and 6B illustrate a method of installation providing 4 recommended glass to mesh separation of 3.25 inches (although 2 inches may be adequate) for (A) a motorized roll up system and (B) a fixed installation.

FIG. 7 illustrates a “luff rope” fixture for a roll up system.

FIG. 8 compares large missile impact test results (in inches—1 inch equals 2.54 cm) for several of the examples.

FIG. 9 compares static load test results of deflection (in inches—one inch equals 2.54 cm) for examples E, F and G.

FIG. 10 shows results of a numerical simulation that shows the simulated displacement matching the displacement that was actually measured from testing of one example of a mesh screen.

FIG. 11 illustrates a numerical finite element simulation for determining out-of-plane displacement of a mesh due to a 4.9 kilogram simulated 2×4 impacting the mesh at a velocity of 22.35 meters per second, when the mesh is preloaded with 2×1000 Newton loads, as shown.

FIGS. 12-18 show an example of a luff rope system for mounting a mesh screen under tension in a rollup shutter assembly.

FIG. 19 shows an example of a mesh screen capable of meeting burglary resistance standards of ENV 1627:1999, classes 1-5.

### DETAILED DESCRIPTION OF PREFERRED EMBODIMENTS OF THE INVENTION

The examples described and the drawings rendered are illustrative and are not to be read as limiting the scope of the invention as it is defined by the appended claims.

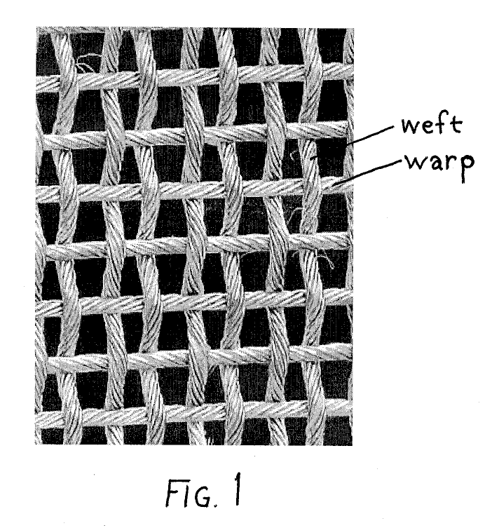

FIG. 1 illustrates an example of a portion of a safety mesh comprising a warp and a weft. The weft is an alternating weft, such that every other weft has the same over and under weave around the warp. Both the warp and the weft are comprised of cables. The cables are comprised of aramid fibers, or other high tensile strength polymer, carbon or glass fibers, as a core and six stainless steel wires, such as 304 stainless steel, spun around the polymer core. For example, six stainless steel wires may be wound around the core such that the core is substantially concealed by the stainless steel wires, preventing the core from being degraded by ultra violet radiation from sunshine, for example.

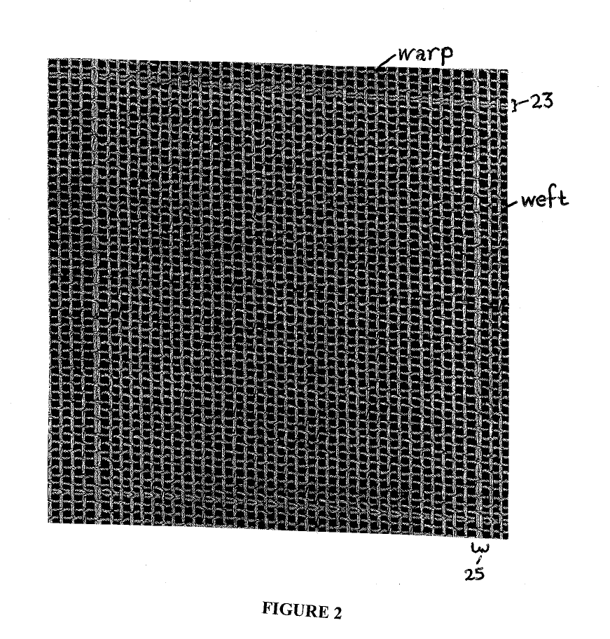

In one example, such as shown in FIG. 2, every 36^{th} warp is comprised of a plurality of cables, such as two cables side by side 25 or three cables spun into a continuous multi-cable strand. Every 50^{th} weft may be comprised of a plurality of cables 23, also. By adding such a plurality of strands in cables used periodically in a mesh, the safety mesh may be made much more resistant to cutting. In one test, neither a cable cutter or razor blade were able to cut through the safety mesh. Although a saw may be used to cut through such a mesh, the mesh is substantially resistant to other cutting tools, such as wire cutters and blades. By spacing the reinforcing plurality of cables periodically throughout the safety mesh, the safety mesh is made substantially resistant to cutting without substantially changing the wind deflection characteristics of the safety mesh.

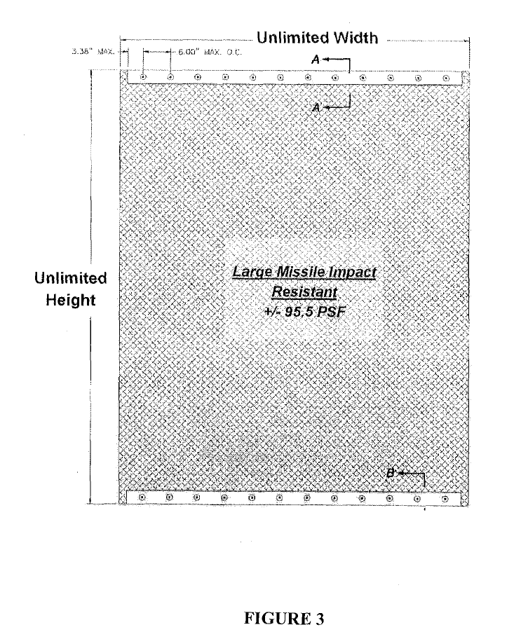

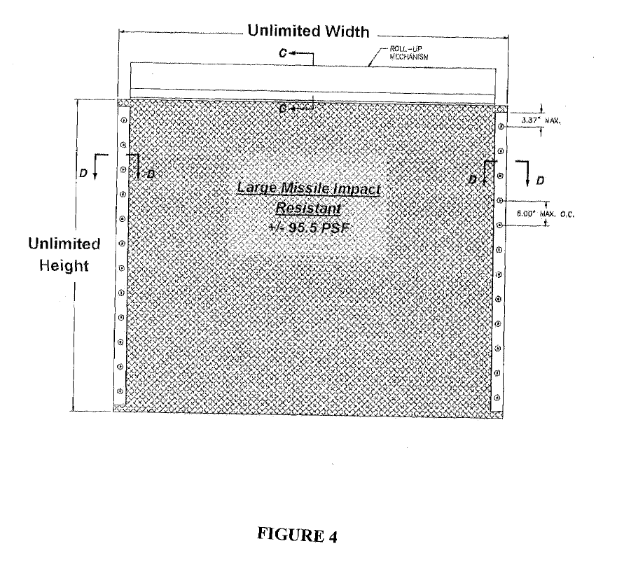

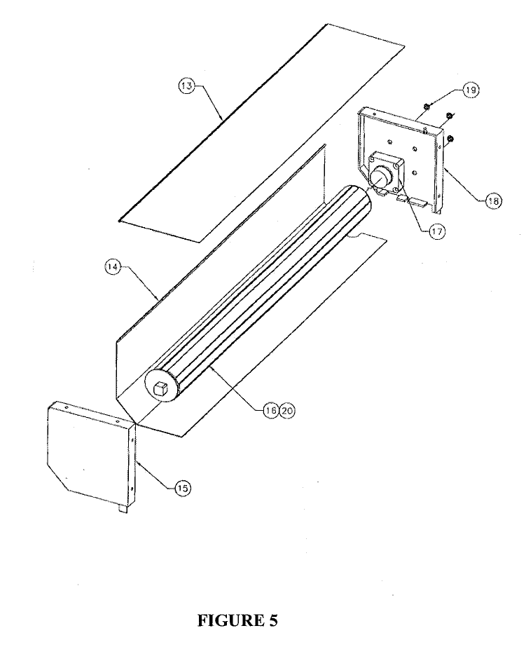

In one example, such as shown in FIG. 3, a safety mesh is secured on the top and bottom by a first fixture and a second fixture, respectively. In another examples, such as shown in FIG. 4, a safety mesh is secured on each side by a first fixture and a second fixture, respectively. Although the drawings show the warp and weft at a 45% angle to the fixtures, the fixtures may be oriented at any angle to the warp. In one example, the fixtures are perpendicular to the direction of elongation of the warp cables. For example, a retaining fixture is fastened to the mesh, such as by rivets, which may be spaced up to 6 inches apart. FIG. 5 illustrates an example of a roll up hood, in an exploded view, that may be used to roll up a safety mesh, having an aluminum motor tube 16, which includes an aluminum bearing housing 20, a first aluminum side bracket 15, a second aluminum side bracket 18 having a motor 17 and motor mounting nuts 19, an aluminum hood front 14, and an aluminum hood top 13. Aluminum is used for its formability, weathering and light weight, but any material may be chosen for a hood cover 13, 14, 15, and 18. The roll down option may be manual or automated using a system capable of being operated remotely, such as by internet and/or wireless access to a controller coupled to the motor 17. Bolts or screws 101 attach the bracket 73,74 to a build-out on the structure providing a minimum glass separation of 3.25 inches.

Many mesh systems and shutter systems fail to achieve the standards required by Miami Dade County in Florida for large missile impacts, static loads and/or under NAMI for hurricane resistant shutter system, configuration “O”, for large missile impact rating of wind zone 4—missile level D. Prior to adopting a mesh made of aramid fibers wrapped in stainless steel wires, other mesh systems were tested and failed including systems comprising aramid fibers and other system including coating fibers and the like. Even the initial tests with cables including aramid fibers and steel wires failed the large missile impact test. Finally, the correct spinning tension, weaving tension parameters, and mounting orientation and hardware were selected to give the aramid core—steel jacketed cables woven into a open mesh the capability of successfully stopping a 2×4 at about 50 feet per second (fps) (which is about 55 km per hour) in less than three inches (less than about 8 centimeters). This daunting challenge required more than two years of design, numerical simulation, and testing. One example is capable of deflecting less than two inches in a static load test with a load of 105 pounds per square foot (psf), which meets the standards of Miami-Dade County in Florida. The same example showed a similar resistance to deflection even in a dynamic large missile impact test, which deflected less than two inches both at the lower left corner and center of the mesh. In another example, the mesh system is designed to have a deflection upon in a large missile impact or static load test at 105 pounds per square foot load of less than three inches.

In one example, a mesh having a mesh with a 1500 denier, aramid fiber core, and a width of eight feet, four inches and a height of seven feet, eleven inches met or exceeded the standards for large missile impact testing, such as those of Miami-Dade County in Florida. To the Applicant's knowledge, this is the only non-solid shutter system to pass this exacting test.

Surprisingly, the amount of open area to closed area makes a significant difference in testing for wind loads and missile impact tests. A range of 20% to 50% of open area to closed area is advantageous for providing an air cushion between the mesh and an underlying surface. In one example, the open to closed area is about 27% to 32%, such as a weave having a density of about 13.5 strands per inch in the warp direction and about 10 strands per inch in the weft direction (i.e. about 32% open area). Open area is defined as the interstices between the warp and the weft. In this example, each of the cables used for the warp and weft are comprised of 1400-1500 denier of a high modulus fiber core and a 6 strand stainless steel wire twined around the aramid fiber core, providing a composite cable having an outer diameter in a range of at least 0.7 mm to no greater than 1.1 mm. Screens having cables with a different outer diameter may have a different optimal range of open area to closed area percentage, which may be selected using numerical simulations, for example.

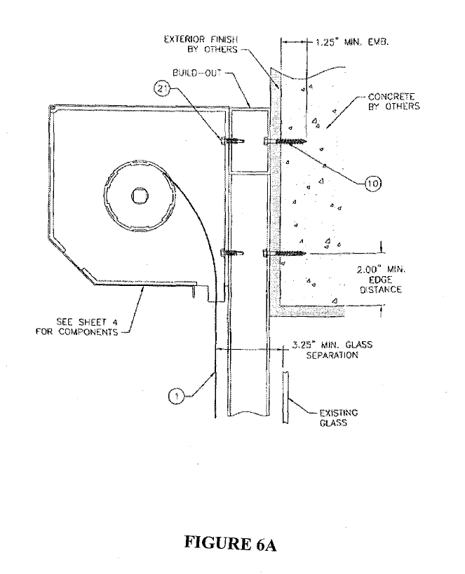

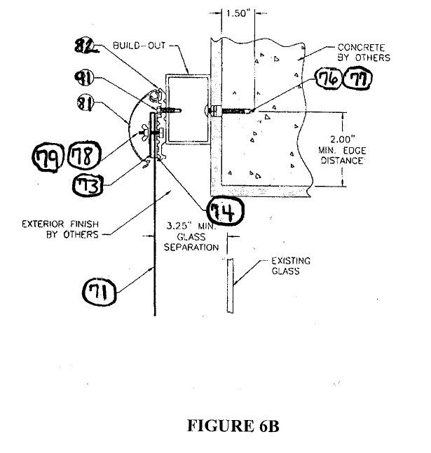

In one example, such as shown in FIG. 6A-6B, a spacer is used to build out the shutter system, such that a space of 3.25 inches (8.3 cm) is provided between the mesh and any glass surface. Alternatively, if any glass surface is already recessed by 3.25 inches or more, then the units may be mounted flush on the surface. In FIG. 6A a roll up system, such as shown in detail in the exploded view of FIG. 5 is installed using a spacer.

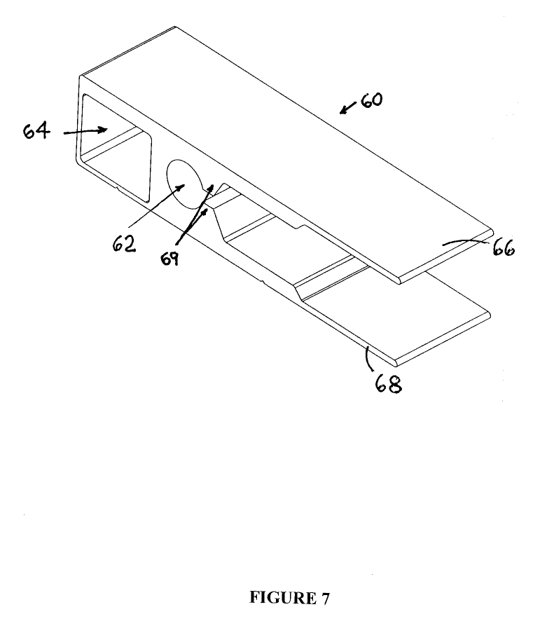

A frame on the left and right side of the opening of the structure is included for mounting of a “luff rope” system for tensioning the mesh by two opposite edges. FIG. 7 illustrates a luff rope fixture 60 for use in a luff rope system having a channel 62 and retainers 69 for slidably retaining a fixture clamped, or otherwise attached, along each edge of a mesh. The guiding extensions 66, 68 serve to feed the mesh along the luff rope fixture 60, while covering any gap between the mesh and the channel 62. The mounting channel 64 is used for fastening the luff rope fixture 60 on a structure, such as using screws, lugs or bolts. For example, a fixture 60 may be mounted along each side edge of a window and/or spacer through holes in the mounting channel 64 on the outside edge of the fixture 60. The inside edges 66, 68 face inwardly and serve as guides and covers. A sliding or rolling keeper is inserted in a channel 62 and is retained in the channel 62 by upper and lower extensions 69. The keeper is coupled to each edge of a mesh, such as known in the art of sailing. Thus, the mesh portion of the mesh deploys down and up using the roll up system of FIGS. 5 and 6A.

In another example, as shown in FIG. 6B, the mesh 71 is fixed on the window manually by folding a portion of the mesh 71 over a stay and/or within a bracket 73,74. Bolts 78 and wing nuts 79 fasten the bracket 73,74 in place. A c-shaped spline on one end 82 of the bracket mates with a corresponding structure on a decorative cover 81 to hide the fasteners 78,79, for example. This cover 81 may be locked in place to prevent an unauthorized removal of the mesh, for example.

In one example, a luff rope is anchored to a mesh oriented such that the warp cables are tensioned between opposite luff rope assemblies. For example, the warp cables may be wrapped around the luff rope and seam welded, such as using ultrasound or friction stir welding. In one example, ultrasound welding is used to form a double seam. A mesh system with a double seam welded using ultrasonic welding to a luff rope system is capable of passing a static load deflection test, even at pressure substantially greater than the ordinary pressure used in a static load test. Indeed, one example of a mesh system mounted by a luff rope system, such as illustrated in FIG. 7, is capable of withstanding a static load of at least 170 psf. A static load of 170 psf is comparable to winds never before recorded in storms on Earth. A mesh system mounted to the luff rope system using an ultrasonically welded double seam may be able to survive a large missile impact test, if the warp cables are oriented such that the warp cables are anchored on either side of the mesh by the luff rope system. In one example, an ultrasonically welded single seam failed during a dynamic large missile impact test, even though it passed a static load test.

The choice of composite cable and construction of the mesh, including the percent open area to closed area, was surprisingly important in preventing deflection during large missile impact tests and under wind loads, such as maximum wind loads of a category 4 hurricane. In one example, a mesh having a percent open area of 27.2% is made having a strand density of 520 strands per m² by 390 strands per m² with an average hole dimension between the nearest strands of 1.82 mm (+0.05 mm) by 1.23 mm (+0.05 mm). For a 4 meter wide mesh, the weaving tension of the warp is 2.42 kg, and the weft weaving tension is 3.2 kg. The weft weaving tension varies depending on the width of the mesh selected. Preferably, the warp is substantially straight and the weft is woven, alternatingly, over and under each warp strand.

Numerical simulations and testing are used to define a range of openness suitable for a hurricane resistant protective screen for a mesh system. For example, it is thought that a range of percent openness, defined as the percentage of the open space to the total area of the mesh, may be selected in a range from about 20% to 50%. However, at 20% openness there is a substantial deflection due to the wind deflection only, which may result in premature hardware failure of the hardware mounting a screen to a structure, such as a window opening, at wind loads less than 70 pounds per square foot (psf). At 50% openness, there is a substantial deflection upon large missile impact, which may cause the deflection to exceed three inches at less than 50 feet per second. More preferably, a range of openness of at least 25% and no greater than 35% provides a reasonable certainty of passing both the wind deflection test and the large missile impact test. Even more preferably, a range of at least 27% to no greater than 32% is selected as an optimal range of openness that provides for reasonable engineering, installation and manufacturing tolerances, while assuring successful passage of both wind deflection and large missile impact tests.

In one specific example, six 304 stainless steel wires are spun tightly around a 1500 denier core of aramid fibers, such that the core of aramid fibers are completely enclosed by the steel wires. The gauge of the steel wires is selected to be about 0.2 mm in diameter. The spinning provides a cable strand having a diameter of about 0.8 mm. A specialized, but commercially available, spinning machine that allows comparatively high spinning loads is used to spin a cable strand having these structural characteristics, which may be used to make a mesh having comparatively low deflections when impacted in a large missile impact test.

In one example, a mesh may have a color. For example, a mesh colored black, such as by sputter deposition, chemical vapor deposition, or painting, appears more transparent than a mesh having stainless steel exposed. In another example, other colors may be used or patterns may be painted or otherwise formed on the mesh.

In one example, sensor wires are incorporated into one or more cables to detect any damage to the mesh, such as by any attempt at intrusion or storm damage. Such a system may be monitored by a controller and any change in the status of the mesh may be reported, such as by transmission over the internet, email or wireless device.

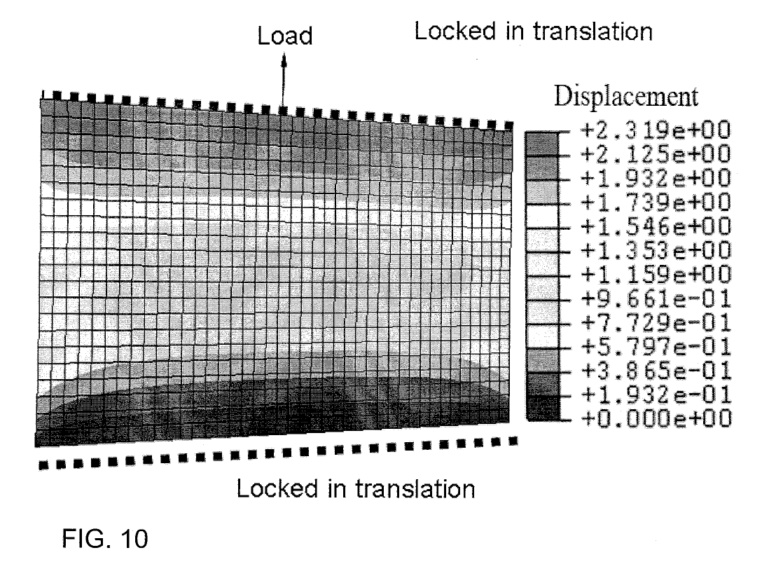

A finite element model was prepared for understanding design characteristics and optimizing properties of a mesh. A small sample was modeled using finite element analysis of an actual test specimen. As shown in FIG. 10, a finite element mesh having a Young's modulus of 11,200 N/mm, assuming mesh stiffness isotropy, matched measured strain of an actual mesh specimen having dimensions 200 mm×100 mm. This Young's modulus was then used in simulations of an impact test finite element model of a screen having dimensions of 3 meters by 3 meters, which is preloaded, as shown in FIG. 11, with two 1000 N loads. The finite element analysis includes pre-loading of a screen in a static load test and dynamic impact tests, such as an impact of a simulated 2×4, having a mass of 4.9 kilograms and a velocity of 22.35 meters per second in one example. Loading, mass and velocity may be adjusted as desired. In an initial analysis only a mesh screen was included in the analysis; however, this did not accurately reflect the impact on displacement in testing, which was influenced by mounting hardware. In additional analysis, mounting hardware was included in the simulations.

In one static load analysis, a finite element mesh mounted on horizontal beams, having a 20 mm×6 mm rectangular cross section, was loaded with a mass of 21 kilograms (simulated static load of 2×4 at center of mesh) and displacement of the mesh was 82 mm (3.23 inches). Using a finite element mesh mounted by horizontal, hollow beams, having an outer cross section of 20 mm×10 mm and an inner cross section of 14 mm×4 mm, to fix the steel/aramid cables of the mesh, a mass of 21 kg resulted in a displacement of 80 mm (3.15 inches), Both of these simulations showed an acceptable displacement under the applied static load. However, a round steel rod (10 mm) or a hollow tube (outer diameter 20 mm—inner diameter 2 mm for hollow rod) resulted in an unacceptable displacement of 140 mm (5.51 inches) and 90 mm (3.54 inches), respectively. Thus, the method of mounting the mesh screen to a fixed structure is an important factor in determining if an example is capable of withstanding wind loads and impacts within design limits.

Surprisingly, actual measured deflections of mesh screens, in some examples, are less than predicted using an isotropic Young's modulus in a finite element simulation. Indeed, actual large missile impact tests show reduced impact displacement is achieved if a mesh screen is mounted such that the warp strands, which are comparatively straight after weaving, are secured at either end, preferably under a preload condition. Mounting the mesh screen diagonally or along the weft strands causes a greater displacement during impact if all else remains the same. It is thought, without be limiting in any way, that the weft strands are comparatively sinuous after weaving, which may allow greater stretching and displacement if the mesh screen is mounted by fixing the weft strand ends in the mounting hardware. Thus, in practice, mesh screens do not have an isotropic Young's modulus. Furthermore, wind loads on a mesh screen and support structure and deflections are much less than estimated from static load tests using an impermeable barrier to impose the load. A mesh screen allows a cushion of air to develop between the window and the screen, which is a barrier to impinging wind and flying debris. The screen and the cushion of air absorb the impact of a large missile, distributing the load instantly (at approximately the speed of sound) across the entire area of the screen. Thus, in practice, the mesh screen is capable of achieving better results than predicted by finite element analysis that does not include anisotropic Young's modulus and an air cushion barrier. An openness in a range from at least twelve percent to no greater than fifty percent is capable of building an air cushion barrier that reduces the deflection of a mesh screen under even category 5 wind loads. More preferably, an openness between twenty percent and forty percent is selected to achieve a deflection of less than 80 millimeters in large missile impact tests, even under wind loads associated with a category 4 hurricane (or better).

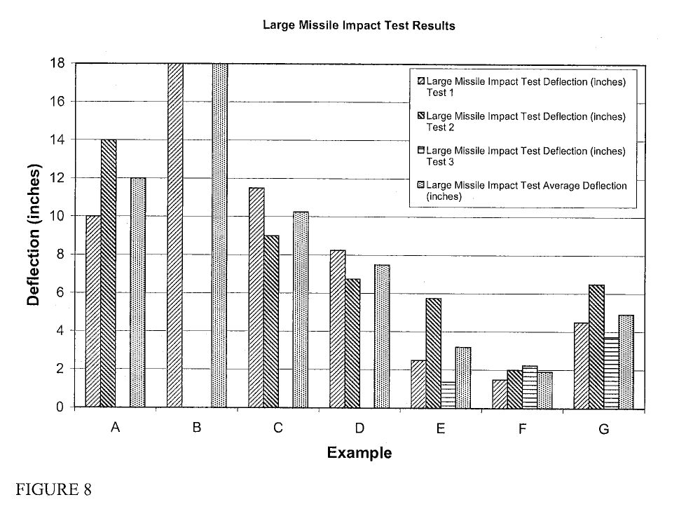

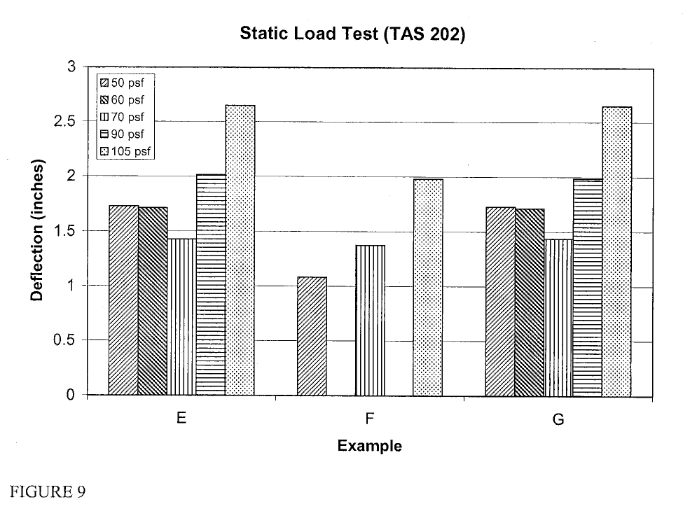

Examples were tested and results are summarized in the bar graphs of FIGS. 8 and 9. Many tests and configurations were tested prior to determining conditions suitable for achieving desired results of impact tests and static load tests that allowed a mesh screen to be able to abruptly stop a large missile in Miami-Dade Counties large missile impact test.

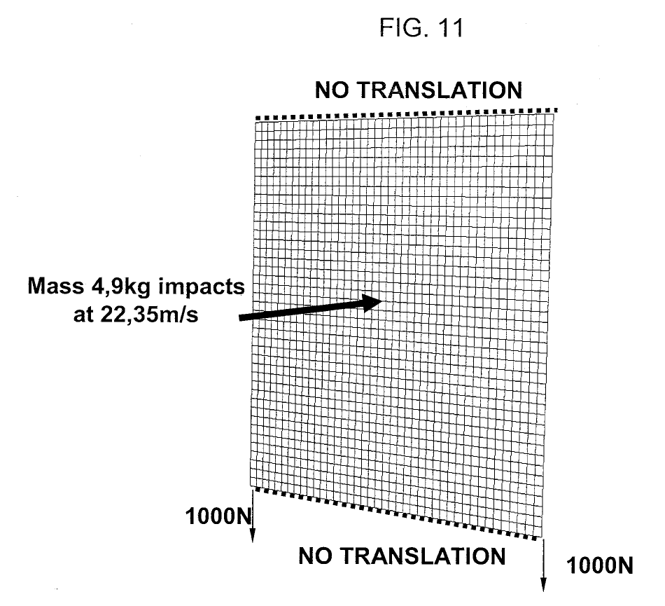

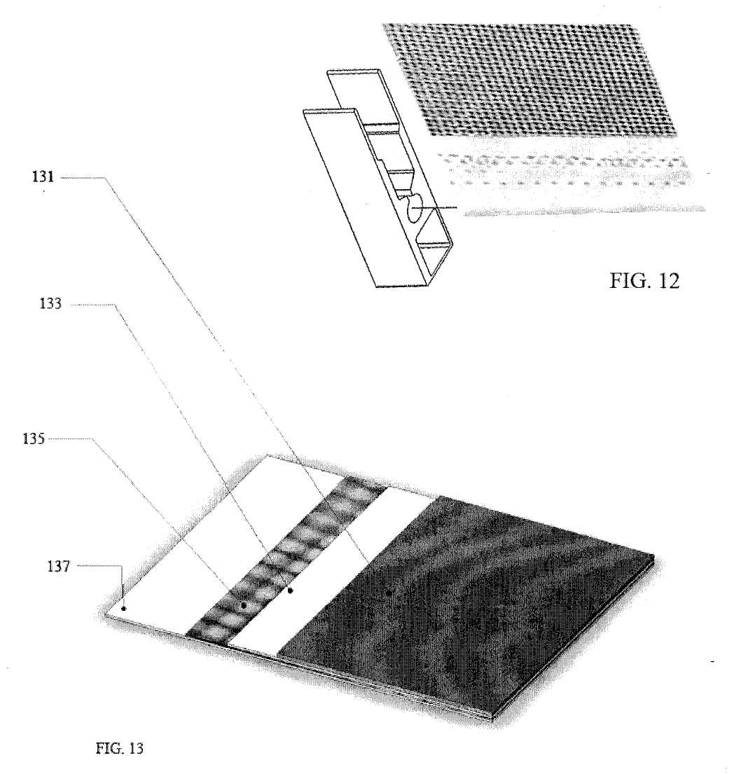

In one example, a deployable mesh screen protective system uses a luff rope and channel system to raise and lower a mesh screen and to retain the mesh screen under tension. One advantage of the luff rope is that the system may be raised and lowered using know, standard rollup shutter systems, while still stopping large missiles without causing greater than 3.25 inch deflection of the mesh screen measured at the point of impact. In many tests, system failure of a luff rope deployment system occurred at the location where the mesh screen is mounted to the luff rope system. In other tests, failure occurred where the luff rope system was mounted in a channel. In one example, a luff rope deployment system successfully deploys a mesh screen capable of abruptly stopping a large missile in a large missile impact test, using an ultrasonically welded, reinforced polymer border binding warp strand ends to luff ropes on opposite sides of a mesh screen. The luff ropes ride in channels mounted to a structure on either side of a mesh screen, and the luff ropes may be placed under tension using a jig or stretching frame to help insert the wrapped luff rope into each channel. The drawing in FIG. 12 illustrates in an exploded plan view a portion of a mesh screen having a luff rope attached at using the multiply film illustrated in FIG. 13. As will be described in FIGS. 13-15, the multiply film envelopes the luff rope and binds it to the mesh screen. In FIG. 12, a portion of an extruded channel is shown into which the luff rope is inserted; a luff rope channel retains the luff rope, while allowing the luff rope to translate along the channel, as is known in raising and lowering sales, for example. The applicants know of no other use of luff ropes for raising and lowering shutters or within the field of this invention. The extrusion may be mounted on a structure to impart a tension on the warp strands of the mesh. In one example a jig is used to stretch the mesh screen during installation of the extrusions on a structure. In another example, the mesh screen is pre-tensioned in the extrusions using framing members. Alternatively, the framing members may be either permanent or temporary. If temporary, then the framing members may be removed after the extrusions are mounted on a structure, for example.

In one example of a luff rope system, a polymer border, such as illustrated in FIG. 15, is affixed securely to opposite sides of the warp direction of a mesh screen. The polymer border may be of a laminate ply construction. For example, plies of an aromatic polyurethane polyether elastomer (TPU) having a 15 mil (0.381 mm) thickness may be ultrasonically welded together on the edge of a mesh screen. In one example the TPU has an opaque medium gray color, a Durometer (hardness) D-224 of 85 Shore A hardness with a regrind permitted of up to 15%. Preferably, the regrind is only from the exact same formula (same resin, type, color & chemistry) without any third party regrind included in the film. It is thought, without being limiting in any way, that the regrind may assist the film in obtaining the desired physical characteristics for mounting a mesh screen. In one example, using no reinforcement ply sheet, the TPU failed to satisfactorily hold the edges of the mesh screen under load. In another example, a reinforcement ply sheet was used with ultrasonic welding, and the TPU failed to satisfactorily hold the edges of the mesh screen under load. Alternatively, radio frequency welding of the TPU reinforced by a reinforcement ply, rather than the more common ultrasonic welding, achieves a luff rope system capable of abruptly stopping a large missile impact in the Miami-Dade large missile impact test. In this example, a reinforcement ply is a urethane layer comprised of aramid fibers (1100-1200 denier and equivalent to Kevlar 29) reinforcing the urethane, which coats the oriented aramid fibers.

In one example, the polymer border was applied and welded to include at least one inch (2.54 cm) of the opposite warp edges of the mesh screen. More preferably, the border includes a welding region B of at least 5 cm, capable of sandwiching the mesh screen edge, providing excellent bonding between the mesh screen and the radio frequency welded polymer facing layers 131 that are laminated to a reinforced polymer sheet, such as illustrated in FIG. 13. In some examples, a range of thickness of the plies for the polymer border was selected within a range of 9 mils (0.228 mm) up to 15 mils (0.381 mm), resulting in a total reinforced composite thickness of about 39 mils (0.9906 mm), for example. An aramid substrate 135 may be laminated between an upper ply 133 of 15 mil (0.381 mm) polyurethane film, and a lower ply 137 of 15 mil (0.381 mm) polyurethane film, as shown in FIG. 13, for example. A weldable polymer layer 131 is laminated to the upper ply 133, for example, in order to improve the binding between the mesh screen and the border.

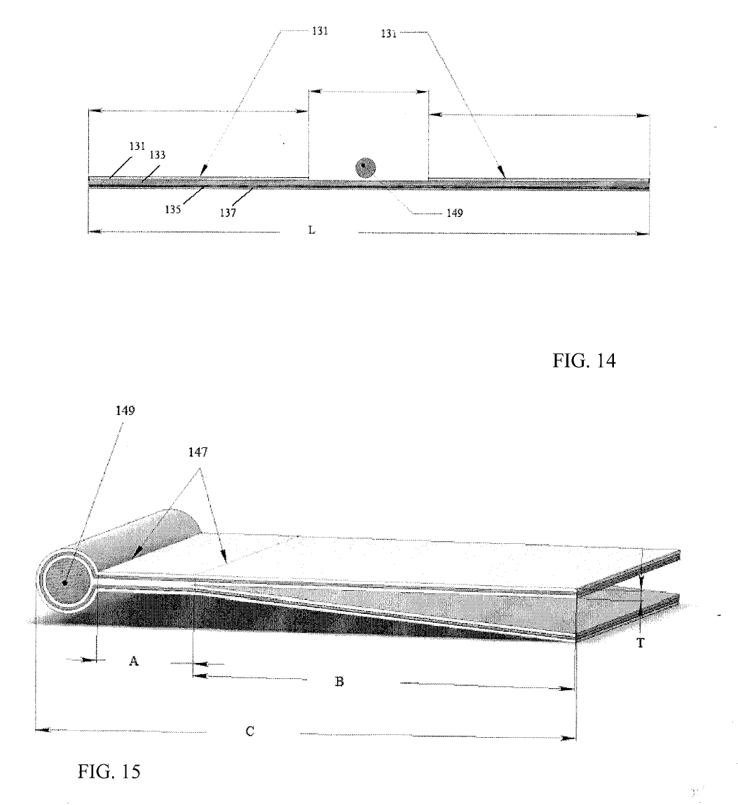

In an example of the process of making the luff rope border, a multi-ply laminated fabric is into 5.5 inch (140 mm) strips. Approximately 2″ (50 mm) wide polyurethane strips 131 of a thickness of about 30 mil (0.762 mm) polyurethane are laminated to both outer edges of the 5.5″ (140 mm) sliced composite multi-ply material, as illustrated in FIG. 13. A luff rope 149 is selected that is comprised of a 3/16″ (4.6 mm) diameter rope of a 100% Polyester, such as a non-crushable rope that is braided with 8 strands. Ends may be terminated with a laser or Heat Knife cut to prevent unraveling. In FIG. 14, the luff rope 149 is centered within the multiply laminated structure of length L, which may be 5.5″ (140 mm), for example. Then, the multiply laminated structure is folded around the luff rope 149, as shown in FIG. 15 and is stitched 147 at the meeting of the two laminated structures and at a distance A from the luff rope 149, which may be about 10 mm, for example. A 6 mm straight stitch may be used for stitching the luff rope 149 at the center of the laminated structure prior to folding the laminated structure and for stitching the opposite sides of the multiply structure together, in one example. A 100% Expanded PTFE twisted fiber thread may be used for stitching, and the size of thread may be 2400 denier, for example. In one example, the polyurethane film is an aromatic polyurethane polyether elastomer (TPU) having a thickness of 15 mil (0.381 mm) & 30 mil 0.762 mm, with a D-224, 85 Shore A hardness, a specific gravity of 1.12, a thermal melting range of 375 to 400 F (190 to 205 C), 100% Strain at 800 psi (5.5 MPa), 300% Strain at 1,200 psi (8.3 MPa), a tensile strength of 5,500 psi (37.9 MPa), ultimate elongation to failure at 500%, a tear strength of 500 lbf/in (87.6 kN/m), abrasion resistance of 30 milligrams loss (H-18, 1000-g Load, 1000 Cycles), a regrind allowance of 5 to 15% of same formula (no third party material). The reinforcing ply 135 may be of an arimid having a modulus equivalent to Kevlar 29, for example, using arimid fibers having a denier of 1100-1200. The fiber fill may be 5 per inch (2.54 cm) warp and 6 per inch (2.54 cm) cavity of weave, with openness of fill spacing pattern of 5/16 inch (4 mm) repeating warp spacing pattern of ⅛ inch to ⅜ inch repeating (2 mm to 5 mm), and a thickness of 9 mils (0.228 mm) to 15 mils (0.381 mm). In one example, the material is sprayed with a urethane adhesive for bonding with an average weight of 56 gsm. In one example, the luff rope is a 100% Polyester, 8 braided strand cover with a filled core with a braided cover having ½ of the strands weaved in the “S” direction and the other ½ of the strands in the “Z” direction, and a core filled with raw fiber having no weaving. A 3/16 inch (4.6 mm) size may be used with ends laser or heat knife cut. Thread may be of a 100% expanded PTFE twisted fiber (Polytetrafluoroethylene) sewing thread having a thread diameter of 2400 denier, a tensile strength of 21 lbs (9.53 kg), and a final twist “Z” stitch.

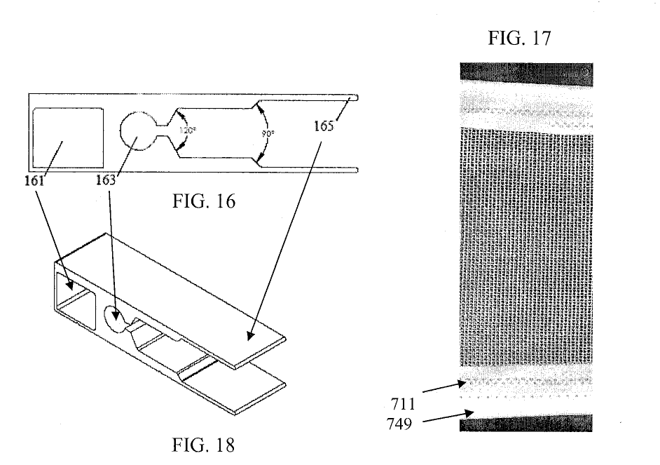

FIG. 16 illustrates an extrusion with a fastening channel 161 for use in mounting the luff rope to a structure, which may be made of a metal, such as aluminum, steel, titanium or the like, a composite, such as a metal matrix composite or fiber reinforced polymer matrix composite and the like, or a ceramic, such as a toughened fiber reinforced carbide, boride or nitride ceramic. The extrusion is preferably very stiff with good tensile strength, strain to failure and toughness, and may be selected to have tribological properties to reduce wear during normal use. For example, the extrusion is of a high stiffness aluminum alloy or a stainless steel. A luff rope channel 163 is capable of retaining a wrapped luff rope 149 allowing free movement of the luff rope 149 along the channel. Extending ends 165 extend outwardly from the luff rope channel 163 covering and protecting a luff rope border from damage by the elements, flying debris and/or manual burglary, for example. FIG. 17 shows a wrapped luff rope 749 and luff rope border 711 ultrasonic or radio frequency welded to a portion of a mesh, and FIG. 18 illustrates a portion of an extrusion in a perspective view, showing the luff rope channel extending along the length of the extrusion. In FIG. 17 both a double seam and a single seam portion are shown.

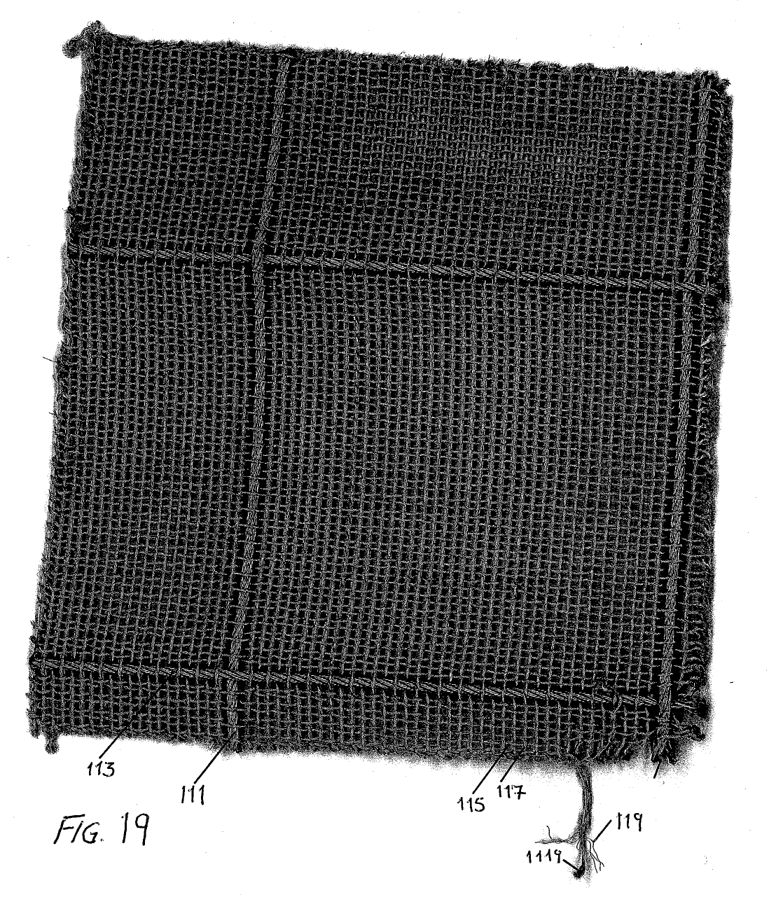

In some examples of a protective mesh screen system, such as shown in FIG. 19, a protective system is burglar resistant, according to the European Standard ENV1627:1999 for windows, doors and shutters. This is a very surprising and unexpected result, as the applicant knows of no other screen to ever meet the standard for a roller shutter static test (at points between locking points—resistance classes 1 and 2 or above) and dynamic test. Furthermore, some examples having additional reinforcing strands achieving surprising resistance to manual burglary attempts in classes 3-5 of the standard. An example of a mesh shown in FIG. 19 illustrates some features of a burglar resistant mesh screen, which has a reinforcing warp cable 111 and a reinforcing weft cable 113 spaced at intervals in the mesh screen that prevent entry into a structure by a burglar. The cables may be comprised of a plurality of the weft/warp strands 115, 117 twisted together to form a cable. In one example, the cables 111, 113 are comprised of twisted 304 stainless steel wire 119, but do not have the bundled polymer fibers 1119, such as aramid in this example, that form the core of the other weft strands 115 and warp strands 117. The cables 111, 113 may be comprised of 7 twisted twine strands, each of which is comprised of 7 spun twisted twine 304 stainless steel wires, such as described in the summary of the invention, without any polymer fibers in the core. One of the seven twisted twine strands may be used as a core with the other six twisted twine strands spun around the core, for example.

Wind speed testing, using fans with wind speeds of 9.4 miles per hour and 7.4 miles per hour for comparison of permeable measured wind speeds behind a mesh screen for the example tested in Example F, below. With a wind speed of 9.4 miles per hour, the measure speed on the opposite side of a mesh screen was 1.9 miles per hour, a reduction of 79.7%. With a wind speed of 7.4 miles per hour, the speed on the opposite side of the mesh screen was 1.0 miles per hour, a reduction of 86.5%. When a window was placed 3.25 inches behind the screen, then no wind speed is measured, because of the cushion air barrier in steady state wind conditions.

### EXAMPLES

See FIG. 8 for comparative results of large missile impact tests for each of the following Examples.

### Example A

Aramid Fibers Without Steel Wires. Aramid fibers having a 1500 denier are woven into a mesh fabric. The mesh fabric is mounted securely as a safety screen in rigid frame. Three large missile impact tests resulted in deflections in a range from ten to fourteen inches, which resulted in failure. Anything greater than three inches is considered a failure.

### Example B

Aramid Fiber Core With Spun Steel Wires (Low Tensile Spinning). In this example a mill was selected that could wind 304 stainless steel wires around a 1500 denier aramid fiber core. However, it is believed that the ordinary range of tension provided by this mill was insufficient to tightly wind the steel wires about the aramid fiber core. Thus, the results of large missile impact for this example was even worse than the results of Example 8. While the steel did not break, it did not contribute to any resistance in deflection, either.

### Examples C to G

Aramid Fiber Core With Spun Steel Wires (high tensile spinning). Additional tension is applied using a specialized spinning machine to tightly spin six 304 stainless steel wires, each having a diameter of about 0.2 mm, around a 1500 denier aramid fiber core, such that the cable strand has a diameter of about 0.8 mm. A screen having a percent openness of 27% was fabricated with a substantially straight wire in the warp direction. A weft wire was woven, alternatingly, over and under the warp wire. The warp tension was 2.42 kg, and the weft tension was 3.2 kg for a 4 meter wide protective screen. Examples C-G were tested with several different frame structures and at different orientations of the anchoring system to the warp and weft directions of the mesh. A passing test is one that results in a deflection of less than three and one-quarter inches, which is the stand-off distance between the mesh system and its underlying structural members, such as a window or a door, which might be damaged by flying debris. The most difficult test to pass for the mesh system is a large missile impact test at a velocity of the large missile of about 50 feet per second (about 55 km per hour). This is a difficult test even for solid structures and impact resistant glass to pass. At this velocity, a 2×4 is capable of penetrating some unreinforced structures. The mesh system passed this test when the mesh was oriented such that a substantially straight warp was anchored at both ends by the framing system, as shown in Example F. Examples E and G show the same exact mesh as in Example F and in the same exact frame mounted in an orientation where the woven weft was anchored at both ends by the framing system. In both of these examples, the mesh failed when the 2×4 impacted on the center of the mesh. Nevertheless, this orientation was better than examples C and D, which used an inferior framing system to anchor the mesh in the frame.

FIG. 9 compares results of Examples E, F and G. Examples E and G are the same mesh oriented in the same direction in the same frame, and the results of the static load deflection show that the results are repeatable. Example F is the same mesh in the same frame, but Example F is oriented with the ends of the warp anchored in the frame. Example F test results are slightly better than E and G, but both of the mesh orientations successfully pass the static load test, meaning that the deflection is less than 3 inches. Static load tests of Examples C and D resulted in frame failures at or below 70 pounds per square foot (psf).

### Example H

High Modulus Polyethylene Fiber Core With Spun Steel Wires. A 1400 to 1500 denier bundle of high modulus polyethylene fibers are spun with steel wires in a process similar to examples C-G. Results are unavailable.

### Example I

Carbon Nanotube/Polymer Core with Spun Steel Wires. High modulus, single-walled nanotubes, such as carbon, silicon carbide and boride nanotubes, are incorporated in polymer fibers or within bundles of fibers to increase the fiber axis modulus and strength. Polymers may include polyamides, such as aramids, and polyethylenes, such as high modulus polyethylenes. In one example, only warp cables include carbon nanotube/polymer cores. Results are unavailable.

### Example J

A mesh screen having an open interstitial spacing between the weft and warp strands of 2.2 mm×2.2 mm had a percent openness of 55% (open area divided by total area time 100 percent), and was mounted similarly to the mesh screen tested in Example F. A large impact test with a 2×4 having a length of 6.2 feet caused a 5.5 inch deflection of the screen, which is greater than the 3.25 inch maximum deflection preferred for a screen capable of abruptly stopping a large missile in the Miami-Dade large missile impact test.

Alternative combinations and variations of the examples provided will become apparent based on this disclosure. It is not possible to provide specific examples for all of the many possible combinations and variations of the embodiments described, but such combinations and variations may be claims that eventually issue.

Conversion Table
PSF to Wind speed

| PSF | MPH |
|---|---|
| 20 | 88.4 |
| 25 | 98.8 |
| 30 | 108.2 |
| 35 | 116.9 |
| 40 | 125 |
| 45 | 132.6 |
| 50 | 139.8 |
| 55 | 146.6 |
| 60 | 153 |
| 65 | 159.3 |
| 70 | 165.4 |
| 75 | 171.2 |
| 80 | 176.8 |
| 85 | 182.2 |
| 90 | 187.5 |
| 95 | 192.6 |
| 100 | 197.6 |
| 125 | 220.9 |
| 150 | 242 |
| 175 | 261.5 |
| 200 | 280 |

Formula ... PSF = (.00256) (V2)
$V = \frac{PSF}{.00256}$

What is claimed is:

1. A mesh system for protecting a structural member needing protection from hurricane winds and missiles carried by hurricane winds, the mesh system comprising:
a mesh formed of a plurality of substantially straight warp cables and a plurality of woven weft cables, each of the plurality of warp cables and the plurality of weft cables comprising a plurality of fibers, the plurality of fibers comprising a core of the cable, and a plurality of wires spun around the plurality of fibers.
a mounting structure for securely anchoring at least the warp cables under tension, such that each of the impacts in a large missile impact test results in a deflection of the mesh of no greater than 8 centimeters, the mesh having a percent openness in a range of at least twenty percent and no greater than fifty percent.

2. The mesh system of claim 1, wherein the frame anchors the plurality of warp cables and the plurality of weft cables.

3. The mesh system of claim 1, wherein the material of the plurality of fibers is selected from a group of materials consisting of nanotubes, aramid fibers, high modulus polyethylene fibers, and combinations thereof.

4. The mesh system of claim 1, wherein the plurality of fibers comprise a bundle of aramid fibers.

5. The mesh system of claim 1, wherein the percent openness of the mesh is selected in a range of at least 25% and no greater than 37%.

6. The mesh system of claim 5, wherein the percent openness of the mesh is selected in a range of at least 27% and no greater than 35%.

7. The mesh system of claim 6, wherein each of the plurality of warp cables and the plurality of weft cables comprise a core of 1500 denier aramid fibers.

8. The mesh system of claim 7, wherein each of the plurality of warp cables and the plurality of weft cables further comprise six stainless steel wires spun around the core.

9. The mesh system of claim 8, wherein each of the six stainless steel wires is of 304 stainless steel.

10. The mesh system of claim 9, wherein each of the six stainless steel wires has a diameter of about 0.2 mm.

11. The mesh system of claim 10, wherein the tension during spinning of the six stainless steel wires is selected such that the mesh system has a deflection in a Miami-Dade large missile impact test of less than 80 mm.

12. The mesh system of claim 10, wherein the tension during spinning of the six stainless steel wires is selected such that the diameter of each of the plurality of warp cables and the plurality of weft cables is about 0.8 mm.

13. The mesh system of claim 12, wherein the warp weaving tension is about 2.4 kg.

14. The mesh system of claim 13, wherein the width of the mesh in the direction of the weft is 4 meters and the weft weaving tension is about 3.2 kg.

15. The mesh system of claim 1, wherein the mounting structure includes a plurality of luff ropes.

16. The mesh system of claim 15, wherein the luff ropes anchor the plurality of warp cables to a luff rope channel.

17. The mesh system of claim 16, further comprising a roll-up mechanism wherein the mesh is anchored to the roll-up mechanism.

18. The mesh system of claim 17, wherein the mesh is anchored to the roll-up mechanism by the plurality of luff ropes.

19. The mesh system of claim 17, wherein the roll-up mechanism and the plurality of luff ropes are capable of deploying the mesh over the structural member needing protection from hurricane winds and missiles carried by hurricane winds.

20. The mesh system of claim 17, wherein the roll-up mechanism and luff ropes are capable of deploying the mesh wirelessly.

21. A process for anchoring a mesh system to a frame, comprising:
folding an edge portion around a luff rope such that the edge portion folds over the luff rope and extends back onto the mesh; and
radio frequency welding the edge portion to the mesh forming a seam between the edge portion and the mesh.

22. The process of claim 21, wherein the step of radio frequency welding includes forming a double seam between the edge portion and the mesh.
